(19) United States
(12) Patent Application Publication
(10) Pub. No.: US 2016/0162809 A1
(43) Pub. Date: Jun. 9, 2016

(54) Enhanced searching and selection of rental properties and associated activities based on historic travel-related data

(71) Applicants: Ryan Hedley Turner, Austin, TX (US); Daniel Steven Haligas, Panama City, FL (US); Velayudhan Venugopal, Austin, TX (US); Alex Holm Devine, Austin, TX (US)

(72) Inventors: Ryan Hedley Turner, Austin, TX (US); Daniel Steven Haligas, Panama City, FL (US); Velayudhan Venugopal, Austin, TX (US); Alex Holm Devine, Austin, TX (US)

(73) Assignee: HomeAway, Inc., Austin, TX (US)

(21) Appl. No.: 14/544,210

(22) Filed: Dec. 8, 2014

(51) Int. Cl. G06Q 10/02; G06Q 30/06

(52) U.S. Cl. CPC G06Q 10/02; G06Q 30/0645

(57) ABSTRACT

An application executing on a computing device (e.g., a wireless computing device) may be configured to monitor and provide channelized stay data that includes tagged activities engaged in by a traveler during a stay at a rental property such as physical presence of the traveler at the rental property during the stay, searches conducted on the computing device, activities selected using the computing device and to verify participation by the traveler in one or more of the selected activities. A networked computing device may receive the channelized stay data and use data included in the channelized stay data to form a search key configured to filter out a subset of rental property listings, which may be of interest to the traveler, from a larger pool of rental property listings. The networked computing device may present the subset of rental property listings on a display of the computing device.

### CROSS-REFERENCE TO RELATED APPLICATIONS

This application is related to U.S. patent application Ser. No. 14/539,970, filed on Nov. 12, 2014, having Attorney Docket No. HOM-152, and titled “Systems And Methods To Modify Direction Of Travel As A Function Of Action Items”, and is related to U.S. patent application Ser. No. 14/562,629, filed on Dec. 5, 2014, having Attorney Docket No. HOM-156, and titled “Adaptive Advisory Engine And Methods To Predict Preferential Activities Available At A Region Associated With Lodging” all of which are herein incorporated by reference in their entirety for all purposes.

### FIELD

The present application relates generally to systems, software, electronic messaging, mobile computing and communication devices. More specifically, systems, applications, computing devices, and methods to facilitate searching and selection of rental properties.

### BACKGROUND

A traveler during a stay at a rental property (e.g., a vacation rental property) may require access to activities in an area where the rental property resides, such as food, drink, cleaning services, entertainment, exercise and the like. Moreover, the traveler may also begin to consider their next vacation and what type of rental property to select for that vacation, for example. Conventionally, the traveler may use a computer, web site, or a search engine to search for suitable rental units in vacation areas of interest to the traveler. More commonly, a traveler may use a mobile device, such as a smartphone or tablet/pad to perform searches for future rental properties, activities in the area around a future rental property, or activities in the area where the traveler is currently vacationing, for example.

However, the traveler will often have to play around with different search parameters to obtain rental property listings that may match the traveler's needs and may have to make changes to those parameters for different travel locations of interest to the traveler, such as different tropical locations, for example. Therefore, the search process may be time consuming and may produce search results that include properties that may not meet the traveler's needs or be in areas where the activities the traveler prefers are not available or are too far away from a prospective rental property.

Thus, there is a need for devices, systems and methods that access information about a traveler's history and use the information to search rental property listings to produce search results having rental properties that match the traveler's needs.

### BRIEF DESCRIPTION OF THE DRAWINGS

Various embodiments or examples (“examples”) of the present application are disclosed in the following detailed description and the accompanying drawings. The drawings are not necessarily to scale:

FIG. 1 depicts one example systems and devices that may be used to enhance searching and selection of rental properties and associated activities for a traveler;

FIG. 2 depicts one example of a computer system;

FIG. 3 depicts an example of a flow diagram for processing channelized data;

FIG. 4 depicts an example of a flow diagram for generating channelized data;

FIG. 5 depicts an example of a block diagram for a content management system; and

FIG. 6 depicts examples 600 of a channelization function and a search results function.

### DETAILED DESCRIPTION

Various embodiments or examples may be implemented in numerous ways, including as a system, a process, a method, an apparatus, a user interface, or a series of program instructions on a non-transitory computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

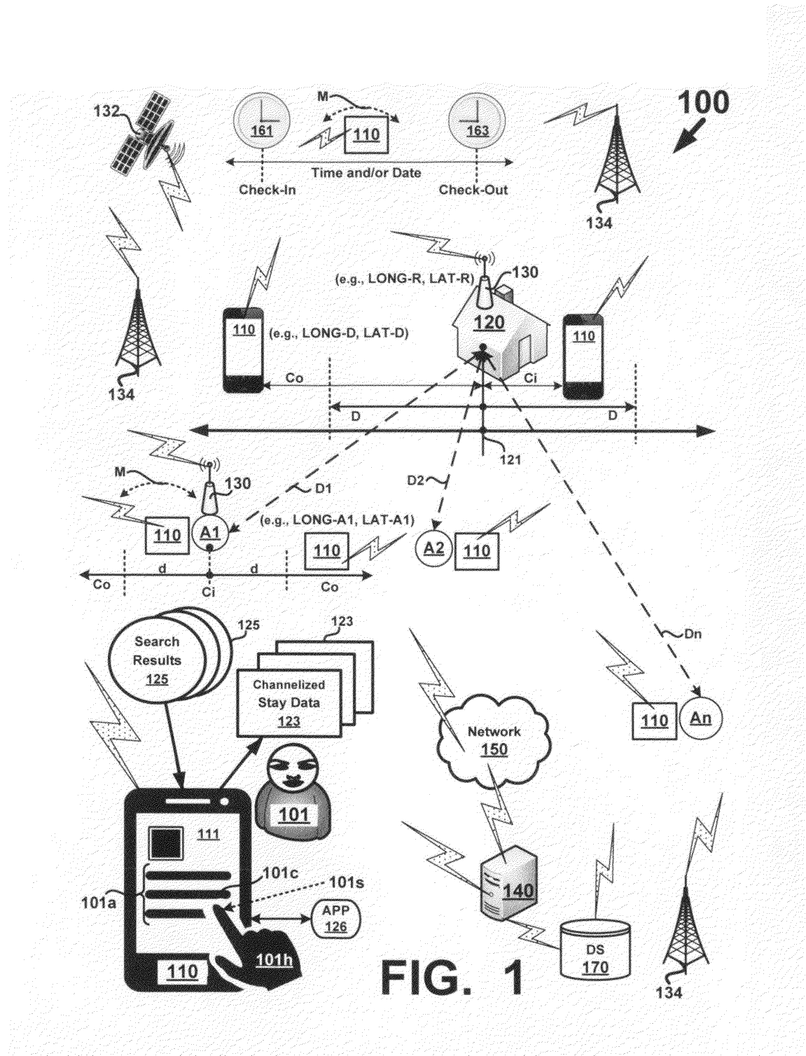

Reference is now made to FIG. 1 where one example 100 of systems and devices that may be used to enhance searching and selection of rental properties and associated activities for a traveler are depicted. In FIG. 1 a traveler 101 (e.g., a user, customer, client, patron, etc.) may have booked a stay (e.g., a reservation for dates, times and a price) for a rental property 120. During the traveler's 101 stay, the traveler 101 may participate in one or more activities denoted A1-An in a region around the rental 120. Traveler 101 may have a computing device on their person, such as a laptop computer, PDA, cell phone, smartphone, tablet, or pad for example. For example, the computing device may be a wireless computing device 110 that may include a display 111 (e.g., a touch-screen display) on which information may be presented for viewing by traveler 101. Traveler 101 may interact with device 110 to enter data and/or to activate information 101a presented on display 111, such as making a selection (e.g., using a finger of a hand 101h or a stylus, etc.) 101s of a specific item 101c presented on display 111 such as an icon, an activity, a rental property listing, a phone number, or other data, images, icons or the like presented on display 111 and generally denoted as 101a. Wireless computing device 110 may be in data communication with other systems and devices using wireless and/or wired communications. For example, wireless computing device 110 may be in communication with a network 150 (e.g., the Cloud, the Internet, a web site), a server 140 or other forms of computing device(s), one or more wireless access points 130 (e.g., a WiFi router), one or more cellular communications networks 134 (e.g., one or more cellular towers), and one or more satellites 132 (e.g., a GPS satellite, a communications satellite).

A location of device 110 (e.g., a geolocation) may be tracked by the device 110 and by other devices and/or systems, such as 130, 132, 134, 150, 140, for example. A location data history that may include data logged for various locations visited by device 110 (e.g., while being carried by traveler 101) may be stored in a data store internal to device 110 (e.g., in non-volatile memory) and/or in other devices and/or systems such as 130, 132, 134, 150, 140, for example.

The location data history and/or other location data generated by device 110 (e.g., via radio frequency (RF) systems, a GPS system, a GPS integrated circuit or chip) and/or generated external to device 110 (e.g., by cellular networks, 134, wireless access points 130, satellite 134) may be used to determine a presence of the traveler 101 at the rental 120 and at other locations in areas around the rental 120 such as at activities A1-An, for example. For purposes of explanation, in FIG. 1, assume traveler 101 has booked a stay at the rental 120 starting at a check-in time and/or date denoted by clock 161 and ending at a check-out time and/or date denoted by clock 163. Further assume that the device 110 accompanies the traveler 101 during the stay. Detection of device 110 (e.g., via it's RF signal and/or geolocation data) may be used to ascertain a presence of the traveler 101 at the rental 120 and at other locations between the check-in 161 and check-out times 163 and may also be used to track movement of the traveler 101 via motion M of device 110, for example.

Now, as for presence of the traveler 101 at rental 120, data from device 110 or other devices (e.g., 130, 132, 134, 140, 150) may access geolocation data representing location data for device 110 and compare that data with a known or computed geolocation for rental 120. As one example, data representing stay data for traveler 101 at rental 120 may include geolocation data for the location of rental 120. Device 110 may access in internal and/or external GPS system to determine its location(s) in an area at and/or around rental 120. For example, stay data for rental 120 may include stay date data (e.g., check-in/check-out times and/or dates) and geolocation data for rental 120 (e.g., in units of longitude LONG-R and latitude LAT-R). Device 110 may access geolocation sources and/or systems (e.g., assisted GPS data or data from 130, 132, 134, 140, 150) to determine location of device 110 (e.g., in units or longitude LONG-D and latitude LAT-D). As one example of a metric that may be used to determine if the traveler 101 (e.g., via device 110) is at the rental 120 or has been at the rental 120 during a time/date in within the check-in/check-out times/dates is to calculate whether or not the device 110 is within a threshold of an allowable distance D from the rental unit 120 during a time, a date or both included in the stay date data. The stay date data may include the times/dates for check-in and check-out and that data may be compared to a time source, such as one clock or other circuitry in device 110 or other system such as 130, 132, 134, 140 or 150, for example. The stay data may include the geolocation data for rental 120 in units of longitude LONG-R and latitude LAT-R, for example. When device 110 is within the allowable distance D, a calculated distance Ci of device 110 from rental 120 will be indicative of Ci being approximately less than or equal to D. On the other hand, when device 110 is not within the allowable distance D, a calculated distance Co of device 110 from rental 120 will be indicative of Co being approximately greater than D. A known coordinate (e.g., in longitude and latitude) of rental 120 (e.g., from stay data) may be compared to a present geolocation of device 110 (e.g., in longitude and latitude). As one example, device 110 and/or another device or system (e.g., 140 or 150) may access location data for rental 120 (e.g., longitude LONG-R and latitude LAT-R) and geolocation data for a current geolocation of device 110 (e.g., longitude LONG-D and latitude LAT-D) and calculate a distance between 120 and 110 (e.g., a straight line distance, great circle distance, etc.). Longitude LONG-R and latitude LAT-L may be root coordinates for a root geolocation of rental 120. An inference may be made that if the calculated distance is less than or equal to D, then the traveler 101 and his/her device 110 are likely at or near the rental 120. Small and or no changes in the current geolocation of device 110 when Ci≦D may be used to determine that the traveler 101 has a persistent location at the rental 120 (e.g., is stationary); whereas, larger changes in the current geolocation of device 110 when Ci≦D may be used to determine that the traveler 101 is moving M about the rental 120 or may be leaving rental 120 (e.g., to attend an activity). Leaving rental 120 may be determined by calculated values that indicate that a distance between 110 and 120 is greater than D (e.g., Co>D).

A content management system, vacation rental platform or some other service or system may use information regarding location of traveler 101 at rental 120 during a time/date indicated in the stay date data or at other locations (e.g., activities A1-An), to provide services, electronic messaging (e.g., email, newsletters, SMS, text, tweets, IM, etc.), push messages, perform rental property listing searches and other communications and services. In regard to activities (e.g., events, happenings, places to shop, eat, relax, entertainment, services, etc.) in locations around rental 120, traveler 101 may patronize and/or participate in activities denoted as activities A1-An. There may be more or fewer activities than depicted.

In one example, traveler 101 may visit activity A1 (e.g., a bowling alley) located a distance D1 from rental 120. Distance D1 may be calculated as described above. A presence of traveler 101 at activity A1 may be determined by geolocation data from device 110 or other devices or systems as described above. In a manner identical to or similar to that described above for rental 120, device 110 positioned within a threshold of an allowable distance d from activity A1 may be indicative of a presence of traveler 101 at the activity A1, such that for distance Ci≦d, there may be an indication that traveler 101 is at or near activity A1 and for distance Co>D there may be an indication that traveler 101 is not at activity A1 (e.g., traveler 101 may be in route to or leaving A1). While at activity A1, geolocation data indicating little or no movement of device 110 may be indicative of the traveler 101 being at rest (e.g., sitting down to eat); whereas, geolocation data indicating movement M of device 110 may be indicative of activity at A1 (e.g., rolling a bowling ball). Traveler 101 may attend other activities such as A2 and An which may be positioned at distances D2 and Dn relative to rental 120 (e.g., rental 120 may have a root geolocation and root coordinate data from which other locations may be measured). Presence, activity, or inactivity of traveler 101 at activities A2 and/or An may be determined using geolocation data as was described above for 120 and A1.

Distances traveler 101 is willing to travel from rental 120 may be estimated by accumulating data over time for distance values between rental properties and activities in the travelers travel history (e.g., data in a traveler history database). In future rental property searches by traveler or by another entity, such as a content management system, known activities that are preferred by traveler 101 and a maximum distance from a rental property that the traveler 101 has traveled to reach one those known activities may be used as a filter for future searches. As one example if the maximum distance from a rental property to an activity attended by traveler 101 has been approximately 12 miles, then a search for suitable rental properties in which some or all of the activities the traveler 101 may historically prefer or that may be pushed or otherwise recommended to traveler 101 may be filtered by eliminating rental property listings that have activities that are more than 12 miles away. Further to the example, if a potential rental listing discovered during a search has 24 activities that are 12 miles or less away and 6 activities that are more than 12 miles away, then that property may still be included in the search results; whereas, another potential rental listing discovered during the search has 8 activities that are 12 miles or less away and 15 activities that are more than 12 miles away, then that listing may be excluded (e.g., filtered out of) the search results.

In other examples, stay data, traveler history data, or other data sources may indicate that travel in a location around a potential rental listing is by limited means of walking, biking, etc., and a number of activities that are close to the rental listing (e.g., in walking distance) and a number of other activities that are further away from the rental listing, may be weighted to determine if the listing will be included in or filtered out of the search results. Actual search parameters, search keys, data used in a search and other parameters and data may be application specific and are not limited to the examples described herein.

In FIG. 1, activities A1 and A2 may be closer to rental 120 (e.g., within 5 miles) and activity An may be further away (e.g., 15 miles). Information about activities A1 and A2 may be pushed or otherwise provided to traveler 101 due to their closer proximity to rental 120; whereas, activity An may not be promoted to or otherwise brought to the attention of traveler 101 due to it being further away from rental 120. A content management system or other system may communicate information to traveler 101 via device 110, such as recommendations for activities, reviews on activities, activities promoted by and/or-vouched for by owners of rental properties, for example.

As one example, services and/or activities local to an area/region of rental 120 that may be of interest to traveler 101 or may be recommended (e.g., via ratings) by previous travelers, an owner of rental 120, owners of other rentals, or a vacation rental agency or the like may be activated upon receiving some form of verification that the traveler 101 has arrived (e.g., checked-in) and is still present in an area around rental 120.

Rental 120 and/or other activities (A1-An) may include wireless access points 130 which may be used to detect RF signals from device 110 that may be used to determine distance of device 110 from the access point 130 using a metric such as received signal strength indicator (RSSI), RF signal strength (e.g., in dBm), near field communication (NFC), and signal ping times, for example. RF signals metrics may be used in addition to geolocation metrics, such as triangulation using cellular networks 134 to determine location of device 110. Calculation of distances between device 110 and rental 120 and/or an activity may be accomplished using hardware in device 110 (e.g., a processor, DSP, GPS circuitry) and/or software (e.g., an application programming interface (API) that may utilize routines and other forms of software to compute distance based on GPS derived data, such as longitude and latitude. An external system and/or computing device such as a server, Internet-based or Cloud-based system may process GPS derived data to compute distance or other metrics such as speed, velocity, travel time, estimated time of arrival, etc. related to device 110. Data representing the RF signal metrics and/or geolocation metrics may be used to determine that data being transmitted by device 110 is being transmitted in-situ from a location at rental 120 or other locations were activities may occur in the area/region around rental 120.

Activities and other information may be presented 101a on display 111 and selection 101s of a specific item 101c of information may be logged or otherwise recorded as a click-through. Actions by device 110 in response to the selection 101s may include generation of channelized stay data 123 that is transmitted (e.g., via a wireless and/or wired communications link) to an external system (e.g., 150, 140). The channelized stay data 123 may include data representing various activities of traveler 101 during the stay at rental 120 that may be detected via the traveler's 101 interaction with and use of device 110, such as searches conducted using device 110, phone calls to/from device 110, location of device 110, purchase made using device 110, metadata generated by device 110, and click-troughs on device 110, just to name a few.

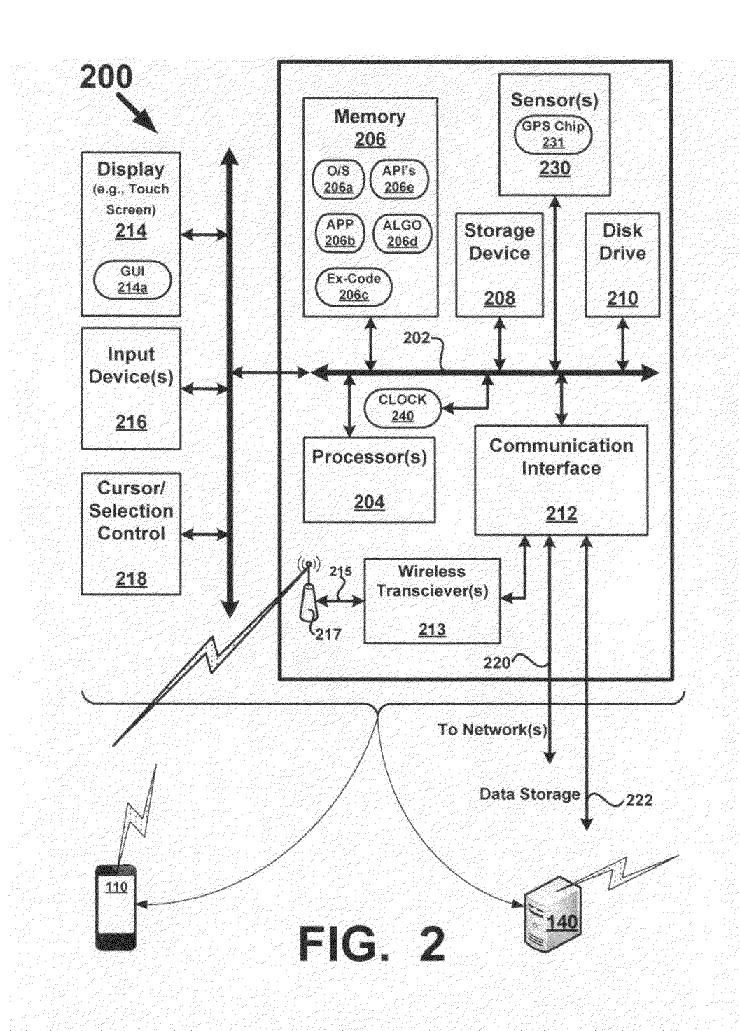

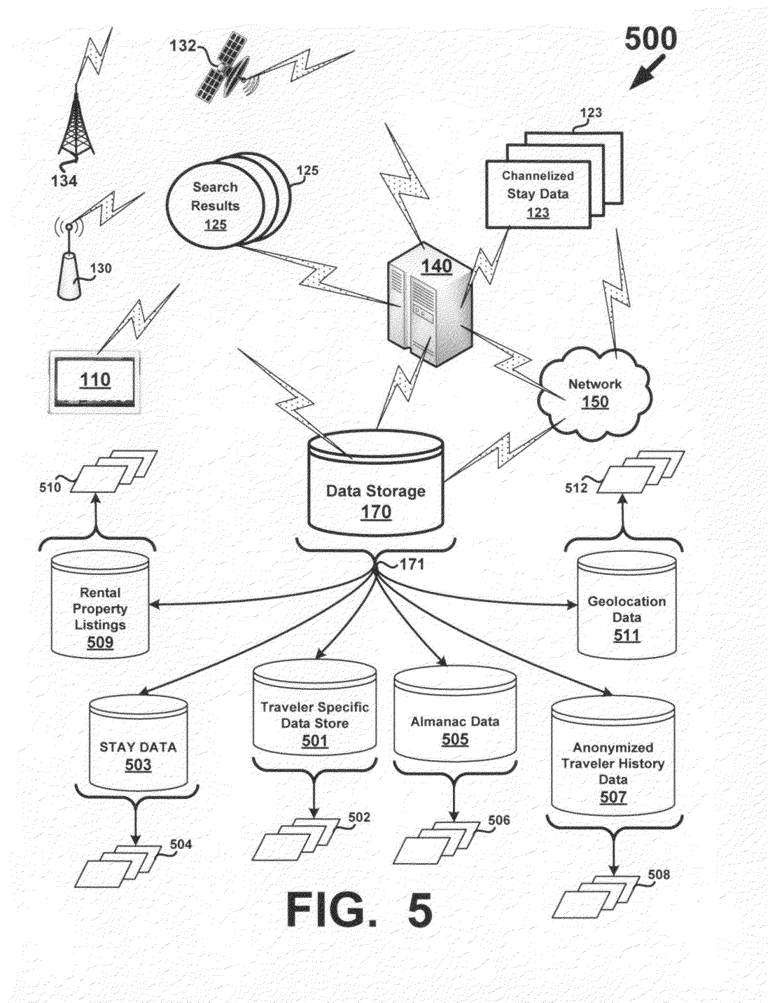

FIG. 2 illustrates an exemplary computer system 200 suitable for use in one or more systems, devices, compute engines, apparatus, traveler devices, owner devices, wireless devices, wireless systems, backend systems, front end systems, networked systems, platforms, data storage devices, data storage systems, external resources, host devices or others described in reference to FIGS. 1 and 5. In some examples, computer system 200 may be used to implement computer programs, algorithms, an application (APP), an application programming interface (API), configurations, methods, processes, or other software to perform the above-described techniques. Computer system 200 may include circuitry, hardware, and other electronic systems to perform the above-described techniques. Computer system 200 may include a bus 202 or other communication mechanism for communicating information, which interconnects subsystems and devices, such as one or more processors 204 (e.g., μC, μP, DSP, ASIC, FPGA, Baseband, etc.), system memory 206 (e.g., RAM, SRAM, DRAM, Flash), storage device 208 (e.g., Flash, ROM), disk drive 210 (e.g., magnetic, optical, solid state), communication interface 212 (e.g., modem, Ethernet, WiFi, Cellular), display 214 (e.g., CRT, LCD, LED, OLED, touch screen), input device 216 (e.g., keyboard, stylus, touch screen, mouse, track pad), and cursor control 218 (e.g., mouse, trackball, stylus). Some of the elements depicted in computer system 200 may be optional, such as elements 214-218, and one or more clocks 240 which may provide temporal data, for example, one or more sensors 230 which may provide location data, rate of motion data and other data associated with movement (e.g., of traveler 101), and computer system 200 need not include all of the elements depicted. Display 214 may present a user interface (UI), such as a graphical user interface (GUI) 214a. Memory 206 may include computer executable programs and/or data embodied in a non-transitory computer readable medium, such as an operating system (OS) 206a, an application (APP) 206b, executable code (Ex-Code) 206c, algorithms (ALGO) 206d, one or more application programming interfaces (API) 206e, for example. As one example, API 206e may include instructions configured to access GPS data from a GPS system of device 110 (e.g., GPS chip 231) or for assisted GPS.

According to some examples, computer system 200 performs specific operations by one or more processors 204 executing one or more sequences of one or more instructions stored in system memory 206. Such instructions may be read into system memory 206 from another non-transitory computer readable medium, such as storage device 208 or disk drive 210 (e.g., a HDD or SSD). In some examples, circuitry may be used in place of or in combination with software instructions for implementation. The term “non-transitory computer readable medium” refers to any tangible medium that participates in providing instructions and/or data to processor(s) 204 for execution. Such a medium may take many forms, including but not limited to, non-volatile media and volatile media. Non-volatile media includes, for example, optical, magnetic, or solid state disks, such as disk drive 210. Volatile media includes dynamic memory, such as system memory 206. Common forms of non-transitory computer readable media includes, for example, floppy disk, flexible disk, hard disk, SSD, magnetic tape, any other magnetic medium, CD-ROM, DVD-ROM, Blu-Ray ROM, USB thumb drive, SD Card, any other optical medium, punch cards, paper tape, any other physical medium with patterns of holes, RAM, PROM, EPROM, FLASH-EPROM, any other memory chip or cartridge, or any other medium from which a computer may read.

Sensor(s) 230 may include but are not limited to one or more inertial sensors (e.g., an accelerometer, a multi-axis accelerometer, a gyroscope, a magnetometer, etc.), an altimeter, and a barometer, for example. One or more sensors in sensor(s) 230 may be used to determine location data for a device that includes computer system 200 and/or is in communication with computer system 200 (e.g., a client device, a traveler device, an owner device, a smartphone, a merchant device, a tablet, a pad, a laptop, PC, a wireless device, a portal computing device, a computing device, a networked computing device, a platform, a backend service, etc.). One or more of the memory 206, storage device 208, or disk drive 210 may be accessed as a data store for location data from sensor(s) 230, GPS chip 231, or other systems in communication (e.g., via communications interface 212) the computer system 200. Location data may be communicated to/from the computer system 200 via one or more of the wireless transceivers 213.

For example, radio frequency signal sources including but not limited to GPS satellite signals (e.g., signals from one or more GPS satellites 134), terrestrial location transmitters (e.g., one or more cellular towers), WiFi signals, WiMAX signals, WiFi routers, WiFi access points, Bluetooth signals (e.g., Bluetooth beacons), near field communication signals, iBeacons, data from network 150, and content management system 500. Other signal and/or data sources for location data may include but are not limited to audio signals (e.g., ultrasonic signals) and signals and/or data generated by location tracking software (e.g., internal to and/or external to computer system 200), for example. In some examples, location data and/or signals may be communicated wireless communications link and/or a wired communications link. Location data accessed by computer system 200 may include but is not limited to a location history data base (e.g., 170) and location data from other systems or devices (e.g., 130, 132, 134), for example. The location data may be updated, revised or otherwise change on a dynamic basis as device 110 moves around M in areas around rental 120 and/or activities (e.g., A1-An).

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media may include coaxial cables, copper wire, and fiber optics, including wires that comprise bus 202 for transmitting a computer data signal or other signals (e.g., from hardware or circuitry). In some examples, execution of the sequences of instructions may be performed by a single computer system 200. According to some examples, two or more computer systems 200 coupled by communication link 220 (e.g., LAN, Ethernet, PSTN, USB, or wireless network) may perform the sequence of instructions in coordination with one another. Computer system 200 may transmit and receive messages, data, and instructions, including programs, (i.e., application code), through communication link 220 and communication interface 212. Received program code may be executed by processor 204 as it is received, and/or stored in disk drive 210, or other non-volatile storage for later execution. Computer system 200 may optionally include a wireless transceiver 213 coupled with the communication interface 212 and coupled 215 with an antenna 217 for receiving and generating RF signals, such as from a WiFi network, WiMAX network, BT radio, Cellular network, networked computing resources, network 150, client devices (e.g., 110), owner devices, near field communication (NFC), satellite network, data storage network, or other wireless network and/or wireless devices, for example. Examples of wireless devices (e.g., traveler devices) may include but is not limited to those depicted in FIGS. 1 and 5. Communications interface 212 may be coupled 222 with data storage external to computer system 200 (e.g., 170). Communications interface 212 may be coupled with external resources and/or systems, such as those depicted in FIGS. 1 and 5, for example. Computer system 200 may be used to implement a computing device (e.g., 110. 140), a portal computing device (e.g., 130, 132), a networked computing device (e.g., 140), and network 150, for example.

Processor(s) 204 may be coupled 202 with signals from circuity or other hardware systems of computer system 200. For examples, signals from clock 240, sensors 230, and communications interface (e.g., via wireless transceivers 213) may be processed by processor 204 and/or other circuitry to calculate an estimated time of arrival of the device 110 (e.g., due to motion M of traveler 101 carrying device 110) at an activity in a geographic location associated with a stay at rental 120, or other activities. The ETA may be calculated based on time data from clock 240 and one or more of location data (e.g., longitude and latitude coordinates), speed data (e.g., scalar data), or velocity data (e.g., vector data). Speed or velocity data may be calculated from signals from sensors 230, GPS chip 231, and changes in location data as traveler 101 and his/her associated device 110 move M relative to an activity (e.g., a restaurant) or other reference point (e.g., root coordinates of rental 120). Rate of travel (e.g., distance traveled per unit of time) may be calculated using signals from clock 240, sensors 230, GPS chip 231 and/or other location data.

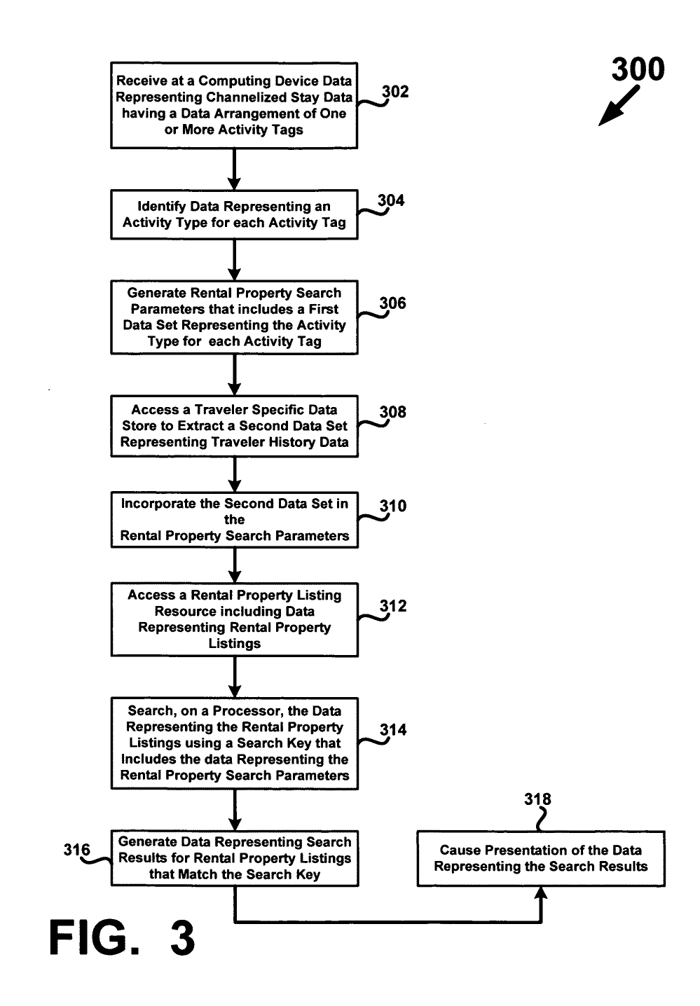

Turning now to FIG. 3 where an example of a flow diagram 300 for processing channelized data is depicted. At a stage 302 data representing channelized stay data (e.g., 123) may be received (e.g., wirelessly) at a computing device (e.g., a networked computing device). The channelized stay data may include a data arrangement or one or more activity tags. At a stage 304 data representing an activity type for each of the one or more activity tags may be identified. At a stage 306 rental property search parameters that include a first data set representing the activity type for each activity tag may be generated (e.g., on server 140). At a stage 308 a traveler specific data store (e.g., 501) may be accessed (e.g., by 140) to extract a second data set representing traveler history data (e.g., 502). At a stage 310 the second data set may be included in the rental property search parameters. At a stage 312 a rental property listing resource (e.g., 509) that includes data representing rental property listings or a subset of rental property listings (e.g., 510) may be accessed. At a stage 314 a processor (e.g., 140) may search the data representing the rental property listings (e.g., 509, 510) using a search key that includes the data representing the rental property search parameters. At a stage 316 data representing search results for rental property listings or a subset of search results for rental property listings that match the search key may be generated (e.g., using processor 140 or other compute engine). At a stage 318 the data representing the search results for rental property listings that match the search key may be caused to be presented (e.g., as images, icon, objects on display 111). Flow 300 may include variations and modifications to the stages depicted, and flow 300 is not limited to the order of the stages depicted in FIG. 3.

As one example, a flow for processing channelized data may include receiving data representing channelized stay data generated during a stay at a rental property at a networked computing device (e.g., 140) and the channelized stay data may have a data arrangement including one or more activity tags. A portion of the data representing the channelized stay data may be generated by a click-through triggered by activation (e.g., 101s) of data representing an image (e.g., 101a) presented on a display (e.g., 111) of a wireless computing device (e.g., 110), and the data representing the image may be included in data representing a recommendation generated by a content management system (e.g., 500) in communication with a networked computing device 9e.g., 140).

As another example, data representing an activity type for each activity tag may be identified, rental property search parameters including a first data set representing the activity type for each activity tag may be generated, and a traveler specific data store may be accessed to extract a second data set representing traveler history data. The second data set may be incorporated in the rental property search parameters. A rental property listing resource (e.g., 509) having data representing rental property listings (e.g., 510) may be accessed. A processor (e.g., 140) may execute a search on the data representing the rental properly listings using a search key that includes the data representing the rental property search parameters. Co-processing among two or more processors may be used to accomplish the searching. Data representing search results for rental property listings that match the search key may be generated (e.g., by 140). Presentation of the data representing the search results may be caused to occur on an external device (e.g., display 111 of device 110) or system (e.g., network 150, the Internet, etc.). As depicted in FIG. 1, the channelized stay data (e.g., 123) may be generated in-situ during the stay at the rental property (e.g., 120) by a processor and/or algorithms of a computing device (e.g., a wireless computing device).

As yet another example, an anonymized traveler data resource (e.g., 507) may be accessed to extract a third data set representing anonymized traveler history data (e.g., data from a pool or travelers that does not identify the travelers the data is garnered from) and the third data set may be incorporated in the rental property search parameters. The third data set may include data representing anonymized activity types and the data representing the search results may include rental property listings having anonymized activity types that match activity types for each of the activity tags.

For example, data representing a selected property listing from the data representing the search results may be received at the networked computing device. Moreover, data representing stay data (e.g., 503) for the selected property listing may be received at the networked computing device. A content management system (e.g., 500) in communication with the networked computing device (e.g., 140) may book a reservation (e.g., for a stay date range and price) for the selected property listing using the data representing the stay data. The content management system may also process payment (e.g., via an electronic payment system) for the booked reservation.

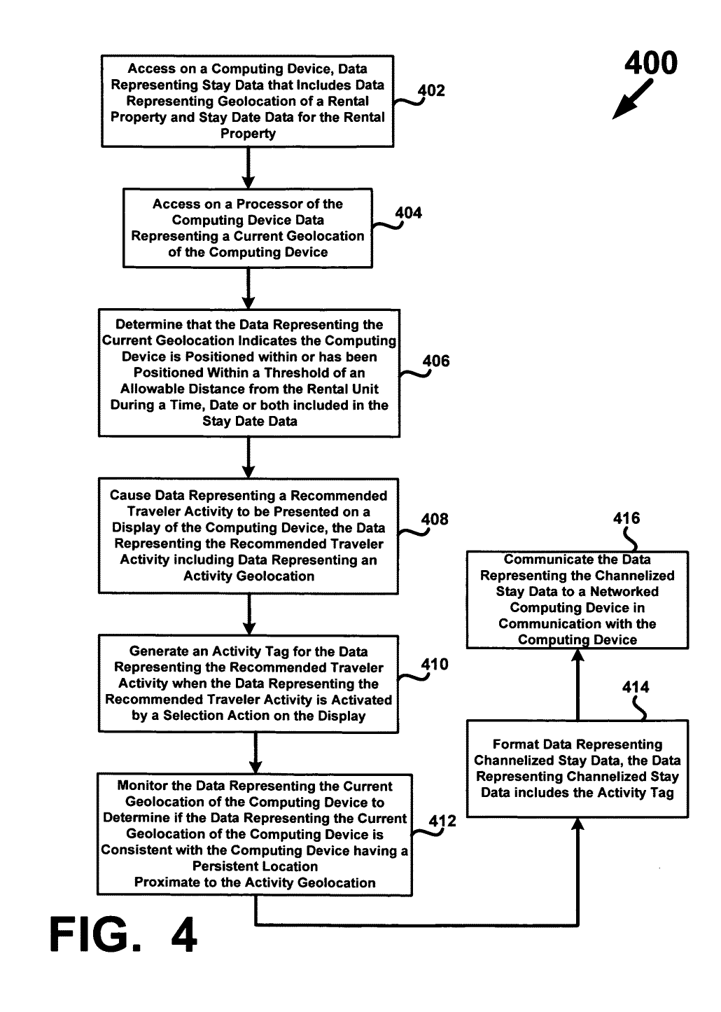

Moving now to FIG. 4 where an example of a flow diagram 400 for generating channelized data is depicted. At a stage 402 data representing stay data (e.g., 503) that includes data representing a geolocation (e.g., LONG-R, LAT-R) of a rental property (e.g., 120) and stay date data (e.g., 161, 163) for the rental property may be accessed from a computing device (e.g., wireless computing device 110). At a stage 404 data representing a current geolocation (e.g., LONG-D, LAT-D) of the computing device (e.g., 110) may be accessed by a processor of the computing device. At a stage 406 it may be determined that the data representing the current geolocation indicates the computing device (e.g., 110) is positioned within or has been positioned within a threshold of an allowable distance (e.g., D) from the rental unit (e.g., 120) during a time, date or both included in the stay date data (e.g., 161, 163). Geolocation data for device 110 may be communicated in real-time or at different time intervals and the geolocation data may be stored in a memory of the computing device and may be accessed at a later time for processing. Accordingly, geolocation data indicating that the computing device was previously positioned within the threshold of the allowable distance may be retained in memory and accessed later to make the determination that at some time during the stay the device 110 was positioned at the rental unit at some distance (e.g., Ci) that was less than or equal to D.

At a stage 408 a processor (e.g., of device 110) may cause data representing a recommended traveler activity (e.g., an equestrian activity) to be presented on a display (e.g., 111) of the computing device (e.g., 110). The data representing the recommended traveler activity may include data representing an activity geolocation for the recommended traveler activity. The activity geolocation may be used to determine if the traveler device 110 via its geolocation data is present at the activity geolocation (e.g., Ci≦d in FIG. 1).

At a stage 410 an activity tag (e.g., for inclusion in the channelized stay data 123) for the data representing the recommended traveler activity may be generated when the data representing the recommended traveler activity is activated by a selection action (e.g., 101s) on the display (e.g., 111) the data representing the recommended traveler activity is presented on.

At a stage 412 the data representing the current geolocation of the computing device may be monitored to determine if the data representing the current geolocation of the computing device is consistent with the computing device having a persistent location proximate to the activity geolocation (e.g., LONG-A1, LAT-A1 in FIG. 1). A persistent location proximate to the activity geolocation may include device 110 being motionless indicating the traveler 101 is present at the activity (e.g., A1) but is not moving M around (e.g., is seated at a table with device 110), for example. Data other than data representing GPS-based data may be used to determine whether or not traveler 101 is moving M around or is stationary at an activity (e.g., A1-An), the rental property 120 or both, such as data representing sensor signals from an accelerometer, a multi-axis accelerometer, a gyroscope, a piezoelectric device, or other transducers or circuitry (e.g., sensors 230 of FIG. 2). A persistent location proximate to the activity geolocation may include traveler 101 moving M around while at the activity (e.g., bowling with device 110 in the traveler's pocket). Persistence at the location proximate the activity geolocation may include the device 110 staying within the threshold of the allowable distance d (e.g., Ci≦d in FIG. 1) while present at the activity A1.

At a stage 414 data representing the channelized stay data (e.g., 123) may be formatted (e.g., using a processor) and the data representing channelized stay data may include the activity tag. At a stage 416 the data representing channelized stay data may be communicated (e.g., wirelessly) to a networked computing device (e.g., 140) in communication with the computing device (e.g., 110). Flow 400 may include variations and modifications to the stages depicted, and flow 400 is not limited to the order of the stages depicted in FIG. 4.

For example, data representing a subset of rental property listings (e.g., 125) may be received at a wireless computing device (e.g., 110). The data representing the subset of rental property listings may be filtered from data representing rental property listing search results using other data as a portion of a search key. Examples of other data that may be uses as a portion of the search key includes but is not limited to data representing the channelized stay data, data accessed from the anonymized traveler data or both. The search key may include multiple portions with each portion including different types of data.

As another example, information searches on device 110 may be monitored for interaction (e.g., by traveler 101) with information presented on display 111 (e.g., information on local activities, information on rental properties or both). Selection (e.g., 101s) of information presented on display 111 may be used to generate another activity tag for data representing the information search. The another activity tag may be included in the data representing the channelized stay data.

Referring now to FIG. 5 where an example of a block diagram for a content management system 500 is depicted. Content management system 500 may include but is not limited to computing device 140 (e.g., a networked server or networked computing device), and data storage 170. In FIG. 5, computing device 140 may be a networked computing device that is in communication (e.g., wired and/or wireless) with other devices and systems, such as traveler device 110, wireless access points 130, cellular networks 134, network 150, and data storage 170. Networked computing device 140 may receive data representing channelized stay data 123 (e.g., as transmitted by traveler device 110) and may transmit search results 125 (e.g., or a subset of search results 125) which may be received and presented on display 111 of traveler device 110. Geolocation data used to determine a location of activities (e.g., A1-An), traveler device 110 and by inference a location of traveler 101, and distances (e.g., Co, Ci) may originate in and/or be communicated by one or more devices and/or systems such as satellite 132, traveler device 110, wireless access points 130, cellular networks 134, network 150, data storage 170, and networked computing device 140. For example data storage 170 may include geolocation data for a location of rental 120 and/or activities in an area/region around a rental property.

Data storage 170 may include one or more data storage resources 171 that may be accessed for read/write by networked computing device 140 and/or other devices and systems, such as traveler device 110, wireless access points 130, cellular networks 134, and network 150, for example. Data storage 170 may be a single data resource or may include one or more other data storage resources that may be configured to store different types of data associated with the data specific to traveler 101, data on other travelers, data on rental properties, stay data, data on rental property listings, geolocation data, and almanac data, just to name a few, for example.

Examples of other data storage resources include but are not limited to: (a) a traveler specific data store 501 which may include data accumulated over time and data collected in real-time (e.g., as the data is generated) or near real-time (e.g., within minutes or hours of the data being generated). The traveler specific data store 501 may include demographic data on traveler 101, preferences of traveler 101, previous travel and/or rental history of traveler 101, contact information on traveler 101, friends, associates, family members, spouse, or other persons who may associate with and/or travel with traveler 101, economic information on traveler (e.g., spending power, financial status, etc.), just to name a few; (b) stay data 503 may include information on stays for a pool of rental properties, such as rental 120 and other rental properties, Stay data 503 may include geolocation data for rental properties, check-in and check-out dates/times for rental properties that have booked stays (e.g., data from booking a reservation), known activities around rental properties, recommendations for activities, policies for rental properties (e.g., no pets, no smoking), directions to get to/from rental properties, etc., just to name a few; (c) almanac data 505 may include data on weather, climate, weather forecasts, tidal data, and other weather and/or climate related data on a pool of rental properties etc., just to name a few. The almanac data 505 may be used as part of the search key to filter out property listings that do not match preferences of the traveler 101 as to weather or climate. For example, if traveler 101 only travels to tropical locations, then rental property listings not located in tropical regions may not be include in the search results 125; (d) anonymized traveler history data 507 may include data on a pool of travelers that has been accumulated over time and/or in real-time or near real-time; however, specific identities of the travelers the data 507 is derived from is not included in the data 507 and may be scrubbed or otherwise quashed from the data to preserve privacy rights and ensure anonymity. Anonymized traveler history data 507 may include demographic data on travelers, spending patterns, vacation patterns, personal preferences, activities participated in by travelers, distance between rental units and activities participated in by the travelers, stay data for travelers, etc., just to name a few; (e) rental property listings 509 may include a pool of rental properties that may be searched (e.g., using the search key) to find rental properties that may match preferences of traveler 101 and/or search parameters provide by traveler 101 or by device 110 (e.g., via APP 126), for example. Rental property listings 509 may be a global data store for all rental property listings on a global scale or may be a localized data store for all rental property listings in a region, state, country, or vacation destination, for example. Search results that list one or more rental property listings from 509 may be further refined to refine the prior search with a new search having a different search key that may be used to generate a sub-set of rental property listings for presentation on device 110; and (f) geolocation data 511 may include geolocation data for traveler device 110, computing devices (e.g., wireless devices) of anonymous travelers, distances between a device and a root coordinate of a rental unit, distances between and device and an activity, just to name a few. Geolocation data may include longitude and/or latitude coordinates for devices, rental units, and activities, for example.

Data stores 501-511 may be accessed by networked computing device 140 or other devices and/or systems and additional data, data structures, files, intermediate results from computations, tags, and the like may be generated for one or more of the data stores 501-511 as denoted by 502-512. One or more of the networked computing device 140, the device 110, the network 150 may access the data stores depicted in FIG. 5 and apply a search key having one or more search parameters that may be used to search the data stores depicted in FIG. 5 and return search results for listings that may be of interest to traveler 101 or that may be more relevant to traveler 101 based on the traveler's 101 history and similar history or traits from the anonymized traveler history data 507, for example.

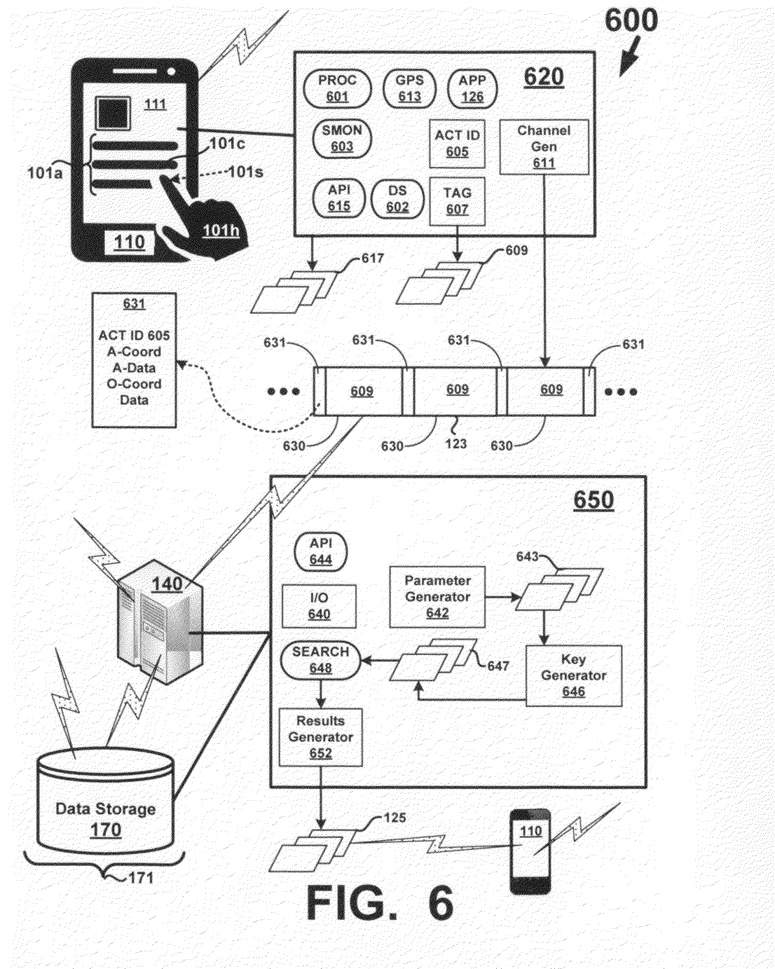

In FIG. 6 examples 600 of a channelization function 620 and a search results function 650 are depicted. The channelization function 620 may include hardware (e.g., data storage DS 602 and GPS system 613), software or both to create data representing channelized stay data 123 using one or more systems of wireless computing device 110. Similarly, search results function 650 may include hardware (e.g., server 140, DS 170, DS 171), software or both to create data representing search results for rental property listings 125.

Channelization function 620 may include a selection monitor circuit (SMON) 603 coupled with a processor (PROC) 601 to detect activation by selection 101s or one or more images 101a presented on display 111, such as icons, text, hypertext, objects or other displayable data formats representing activities presented from searches (e.g., using a browser or APP 126), push notifications, or other forms of electronic messaging. Selection 101s of a specific item 101c or multiple items may be detected by SMON 603. Application (APP) 126 may receive data representing the selected items and parse the data received to generate an activity tag (TAG) 607 and an activity identifier (ACT ID) 605. There may be as many TAG's 607 as activities selected as denoted by one or more datum 609.

APP 126 may parse data representing the selected item(s) 101c and perform a key word search or use a look-up table to determine activity types for the ACT ID 605 of each TAG 607. Activities that are presented to device 110 (e.g., by content management system 500) may include data representing the activity type and APP 126 may use that data for ACT ID 605. A channel generator 611 may process data representing the TAG 607 and the ACT ID 605 and generate the data representing channelized stay data 123. The data representing the channelized stay data 123 may be formatted into a data structure, file format or other form for data communication to an external device (e.g., server 140). For example, channel generator 611 may format the data representing the channelized stay data 123 as one or more data packets in which a data payload 630 of the packet may include one or more TAG's 609 and a header 631 or other field associated with each payload may include the ACT ID 605. Header 631 may include other data in addition to the ACT ID 605, such as data representing a coordinate for an activity A-Coord (e.g., geolocation data), data associated with an activity A-Data (e.g., metadata), and other coordinate data (e.g., geolocation data for device 110), distance data (e.g., Ci, Co, D, d), and longitude and/or latitude data, for example.

Channelization function 620 may include one or more API's 615 and a GPS function 613 that may be used to access GPS circuitry of device 110 (e.g., a GPS chip) and/or external GPS resources (e.g., assisted GPS via calls from API 615) such as cellular communications networks 134, wireless access points 130, satellite 132, geolocation data 511 or others. Geolocation data accessed by API's 615 may be used to perform distance calculations such as those described in FIG. 1 in reference to distances Co, Ci, D and d. One or more geolocation datum 617 may be generated by channelization function 620 and may be used by other devices or system in communication with content management system 500. For example, geolocation datum 617 may be included in header 631 or some other data field in the data representing the channelized stay data 123 or some other data structure or file. The data representing the channelized stay data 123 may include more or fewer fields than depicted and may vary in data size (e.g., packet size) as a function of the number of items selected 101s on display 111, for example. While the traveler 101 and device 110 are in-situ at the rental 120 and activities associated with the stay, data representing the channelized stay data 123 may dynamically change in data size and may be communicated to system 500 multiple times due to actions by traveler 101 with respect to device 110 (e.g., performing searches on the Internet or a vacation rental web page), device 110 being present at multiple activities during a course of a day or during a course of the stay at rental 120.

Search results function 650 may include one or more API's 644, an input/output (I/O) unit 640 configured to communicate with a compute resource (e.g., server 140) and/or data storage resource (e.g., 170, 171), a search engine 648, a search parameter generator 642, a search key generator 646, and a results generator 652. Networked computing resource 140 may receive the data representing the channelized stay data 123 and search parameter generator 642 may parse the various data fields or other data structures of 123 to extract the ACT ID's 605 and activity TAG's 609 and generate rental property search parameters 643 that may include one or more data sets that represent activity types for each activity tag. Additional data stores may be accessed and additional data sets may be generated based on data from the additional data stores (e.g., 171). For example, traveler specific data store 501 may be accessed to extract a second data set representing traveler history data.

Key generator 646 may receive the rental property search parameters 643 and generate one or more search keys 647 that include the rental property search parameters 643. Search engine 648 may access or otherwise receive the one or more search keys 647 and perform a search of the rental properties listings 509. Results generator 652 may output the data representing the search results for rental property listings 125 that match the one or more search keys 647. Results generator 652 may format the data in 125 to be compatible with a display (e.g., 111) the data 125 will be presented on. Data 125 may be configured to be activated on a touch screen display, for example.

API's 644 may access resources internal to system 500 and/or external to system 500 to perform functions such as assisted GPS, calculating distances (e.g., Ci, Co, D, d), accessing geolocation data from external resources (e.g., 130, 132, 134), just to name a few, for example.

Although the foregoing examples have been described in some detail for purposes of clarity of understanding, the above-described conceptual techniques are not limited to the details provided. There are many alternative ways of implementing the above-described conceptual techniques. The disclosed examples are illustrative and not restrictive.

What is claimed is:

1. A method, comprising:
receiving at a networked computing device, data representing channelized stay data generated during a stay at a rental property, the channelized stay data having a first data arrangement including one or more activity tags;
identifying data representing an activity type for each activity tag;
generating rental property search parameters that includes a first data set representing the activity type for each activity tag;
accessing a traveler specific data store to extract a second data set representing traveler history data;
incorporating the second data set in the rental property search parameters;
accessing a rental property listing resource having data representing rental property listings;
searching, on a processor, the data representing the rental properly listings using a search key that includes the data representing the rental property search parameters;
generating data representing search results for rental property listings that match the search key; and
causing presentation of the data representing the search results.

2. The method of claim 1, wherein the causing the presentation of the data representing the search results comprises causing an electronic presentation of the data representing the search results on a display of a wireless computing device.

3. The method of claim 2, wherein the data representing the channelized stay data is received at the networked computing device via a communications link between the networked computing device and the wireless computing device, and the channelized stay data is generated in-situ during the stay at the rental property by a processor of the wireless computing device.

4. The method of claim 1, wherein the traveler history data includes one or more of traveler demographics, traveler preferences, traveler geolocation history, and traveler rental property accommodation history;

5. The method of claim 1 and further comprising:
accessing an anonymized traveler data resource to extract a third data set representing anonymized traveler history data; and
incorporating the third data set in the rental property search parameters.

6. The method of claim 5, wherein the third data set includes data representing anonymized activity types, and
wherein the data representing the search results includes rental property listings having anonymized activity types that match activity types for each of the activity tags.

7. The method of claim 1 and further comprising:
accessing a stay data resource to extract data representing a root geolocation of the rental property, the data representing the root geolocation includes root coordinate data for the rental property;
extracting data representing an activity geolocation for each activity tag, the data representing the activity geolocation includes activity coordinate data for each activity tag;
calculating, on the processor, a distance from the rental property to the activity type for each activity tag, using the root coordinate data and the activity coordinate data for each activity tag;
comparing the distance calculated for each activity tag to determine data representing a maximum distance for the activity tag that is furthest in distance away from the rental property;
accessing an anonymized traveler data resource to extract a fourth data set representing distances between anonymized activity types and property listings; and
incorporating the fourth data set in the rental property search parameters,
wherein the data representing the search results includes rental property listings with anonymized activity types having distances that are no greater than the maximum distance away from the rental property listings.

8. The method of claim 7, wherein the calculating the distance comprises extracting data representing a longitude and a latitude from the root coordinate data and from the activity coordinate data.

9. The method of claim 7, wherein the root coordinate data, the activity coordinate data or both include data representing assisted GPS data accessed from one or more GPS systems.

10. The method of claim 1 and further comprising:
receiving at the networked computing device data representing a selected property listing from the data representing the search results;
receiving at the networked computing device data representing stay data for the selected property listing; and
booking, using a content management system in communication with the networked computing device, a reservation for the selected property listing using the data representing the stay data.

11. The method of claim 10, wherein the data representing the selected property listing is generated by selecting data representing an image of the selected property listing presented on a display of a wireless computing device.

12. The method of claim 1, wherein at least a portion of the data representing the channelized stay data is generated by a click-through triggered by activation of data representing an image presented on a display of a wireless computing device, and the data representing the image is included in data representing a recommendation generated by a content management system in communication with the networked computing device.

13. A method, comprising:
accessing on a wireless computing device, data representing stay data for a rental property, the data representing the stay data including data representing geolocation data for the rental property and stay date data for a stay at the rental property;
accessing on a processor of the wireless computing device, data representing a current geolocation of the wireless computing device using a GPS system of the wireless computing device, an assisted GPS data resource in communication with the wireless computing device or both;
determining that the data representing the current geolocation indicates the wireless computing device is positioned within or has been positioned within a threshold of an allowable distance from the rental unit during a time, a date or both included in the stay date data;
causing data representing a recommended traveler activity to be presented on a display of the wireless computing device, the recommended traveler activity including data representing an activity geolocation;
generating an activity tag for the data representing the recommended traveler activity when the data representing the recommended traveler activity is activated by a selection action on the display;
monitoring the data representing the current geolocation of the wireless computing device to determine if the current geolocation is consistent with the wireless computing device having a persistent location proximate to the activity geolocation;
formatting data representing channelized stay data, the data representing the channelized stay data includes the activity tag; and
communicating the data representing the channelized stay data to a networked computing device in communication with the wireless computing device.

14. The method of claim 13 and further comprising:
receiving at the wireless computing device data representing a subset of rental property listings, the data representing the subset of rental property listings is filtered from data representing rental property listing search results using the data representing the channelized stay data as a portion of a search key.

15. The method of claim 13 and further comprising:
monitoring on the processor, interaction with the display indicating selection of data representing an information search for one or more of information on local activities, information on rental properties or both; and
generating another activity tag for the data representing the information search, the data representing the channelized stay data includes the another activity tag.

16. The method of claim 15 and further comprising:
receiving at the wireless computing device data representing a subset of rental property listings, the data representing the subset of rental property listings is filtered from data representing rental property listing search results using the data representing the channelized stay data as a portion of a search key.

17. The method of claim 13 and further comprising:
extracting first longitude and latitude coordinates from the data representing the geolocation for the rental property and second longitude and latitude coordinates from the data representing the current geolocation of the wireless computing device;
calculating on the processor, a distance between the first longitude and latitude coordinates and the second longitude and latitude coordinates;
determining that the distance is within the threshold of the allowable distance;
generating another activity tag for data representing a presence of the wireless computing device at the rental property; and
formatting the data representing the channelized stay data to include the another activity tag.

18. The method of claim 13, wherein the assisted GPS data resource comprises at least one wireless access point, at least one cellular communication network or both.

19. The method of claim 13, wherein the GPS system comprises a GPS integrated circuit in communication with the processor.

20. The method of claim 13 and further comprising:
receiving at the wireless computing device data representing a subset of rental property listings, the data representing the subset of rental property listings is filtered from data representing rental property listing search results using the data representing the channelized stay data as a portion of a search key and data accessed from an anonymized traveler data resource as another portion of the search key.
